(19) United States
(12) Patent Application Publication
(10) Pub. No.: US 2026/0329889 A1
(43) Pub. Date: Oct. 22, 2026

(54) SYSTEMS AND METHODS FOR EFFICIENT ROW-LEVEL REPLICATION TO DATA LAKE TABLES USING LOGICAL ROW IDENTIFIERS

(71) Applicant: Snowflake Inc., Menlo Park, CA (US)

(72) Inventors: David Christensen, Lawrence, KS (US); Martin Cornelis Frederik Slot, Haarlem (NL)

(21) Appl. No.: 19/649,445

(22) Filed: Apr. 16, 2026

Related U.S. Application Data
(60) Provisional application No. 63/790,418, filed on Apr. 17, 2025.

(51) Int. Cl. G06F 16/27

(52) U.S. Cl. CPC G06F 16/27

(57) ABSTRACT

The subject technology receives change data capture events from a source database, each change data capture event comprising a row key and indicating one of an insert, update, or delete operation. The subject technology maintains in a replicator database a key-to-identifier mapping that associates each row key with a logical row identifier and a row value, a delete queue that stores logical row identifiers for rows pending deletion from a data lake table, and an identifier-to-range mapping that associates ranges of logical row identifiers with file locations in the data lake table. The subject technology processes each change data capture event by updating at least one of the key-to-identifier mapping or the delete queue based on an operation type and a state of the logical row identifier associated with the row key. The subject technology periodically executes a flush operation.

### CROSS-REFERENCE TO RELATED APPLICATIONS

This application claims priority to U.S. Provisional Patent Application No. 63/790,418, filed on Apr. 17, 2025, entitled “METHODS AND APPARATUS FOR MANAGING STREAMING CHANGES TO DATA LAKE TABLES AND REPLICATING CHANGES FROM AN OPERATIONAL DATABASE SYSTEM TO A DATA LAKE TABLE,” and the contents of which are incorporated herein by reference in its entirety for all purposes.

### TECHNICAL FIELD

Embodiments of the disclosure relate generally to database management systems and data lake technologies, specifically to systems and methods for integrating data lake functionality within traditional relational database management systems (RDBMS).

### BACKGROUND

Data lake tables are relational database tables that are stored as a collection of data and metadata files in object storage. The data lake table metadata files describe the state of the table and history of transactions on the table. The current state of the data lake table may be kept in a database to ensure transactional consistency. External software systems can query data lake tables directly by obtaining the current state of a data lake table and its location in object storage from the database via a network application programming interface (API), and then retrieving the data lake table data files and metadata files directly from object storage. The combination of database and API is referred to as the “catalog”, and the network API as the ”catalog API”.

### BRIEF DESCRIPTION OF THE DRAWINGS

The present disclosure will be understood more fully from the detailed description given below and from the accompanying drawings of various embodiments of the disclosure.

FIG. 1 illustrates a high-level system architecture for a streaming data replication system in accordance with one or more embodiments of the subject technology.

FIG. 2 illustrates a detailed operational flow diagram of the replicator component and its interaction with the replicator database in accordance with one or more embodiments of the subject technology.

FIG. 3 illustrates a detailed operational flow diagram of the compaction process performed by the compactor component in accordance with one or more embodiments of the subject technology.

FIG. 4 illustrates a high-level process flow diagram showing the end-to-end operation of the streaming data replication system in accordance with one or more embodiments of the subject technology.

FIG. 5 illustrates an example state progression of Key-ID Mapping and Delete Queue data structures as they process a sequence of change operations in accordance with one or more embodiments of the subject technology.

FIG. 6 is a flow diagram illustrating operations of a system in performing a method, in accordance with some embodiments of the present disclosure.

FIG. 7 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Deletions in data lake tables can be expressed in several ways. A first approach involves rewriting data files to exclude deleted rows, which is computationally expensive to write because a small number of changes may trigger rewriting of large data files. A second approach involves listing the deleted primary keys in deletion files and filtering them out at query time, which is inexpensive to write but computationally expensive to read because the primary keys in the deletion files must be joined against the primary keys in the data files during query execution. A third approach involves listing the deleted physical row offsets in deletion files and filtering them out at query time, which reduces query-time cost relative to the second approach. The first approach is impractical for change data capture purposes because a small number of changes triggers large rewrites. Some existing change data capture solutions for data lake tables use the second approach, but the query-time join on primary keys is expensive. Some solutions use the third approach by performing large merge operations that involve scanning the entire data lake table to locate the physical row offsets at which rows matching the primary keys are found, which is an O(N) operation where N is the number of rows in the table.

In one or more embodiments, a system and method are provided for applying a stream of row-level changes to data lake tables, where the row-level changes comprise insert operations, update operations, and delete operations. The system includes specialized data structures for recording changes to data lake tables and an algorithm for efficiently applying these changes to the data lake tables. The system further includes a compaction process for consolidating multiple data files stored within the data lake into a reduced number of larger data files. In particular embodiments, the system captures a stream of changes from an operational database and replicates these changes to one or more data lake tables, thereby implementing logical row-level data replication between an operational database system and a data lake storage system.

Such embodiments advantageously enable efficient tracking and application of a stream of row-level changes to a data lake table. In some embodiments, a database system stores both the specialized data structures for tracking changes and manages the data lake tables themselves, providing integrated change tracking and data lake management. In other embodiments, the database system accepts logical replication from a separate and independent operational database system, enabling replication across heterogeneous database platforms. The specialized data structures maintained by the database system enable efficient processing of individual change operations while maintaining consistency between the operational database and the data lake table.

By utilizing specialized data structures that are stored in a replicator database, the computational cost of applying individual changes is reduced to aO(log(N)) lookup operation to process each individual change (where N is the number of rows in the data lake table) followed by an O(C) batch operation to flush C accumulated changes to the data lake.. The background compaction process scans and rewrites only those files that have been recently modified, rather than performing full table scans. This method remains efficient and maintains replication performance even as the size of the data lake table grows, because the specialized data structures are many times smaller than the source data and enable incremental processing of changes.

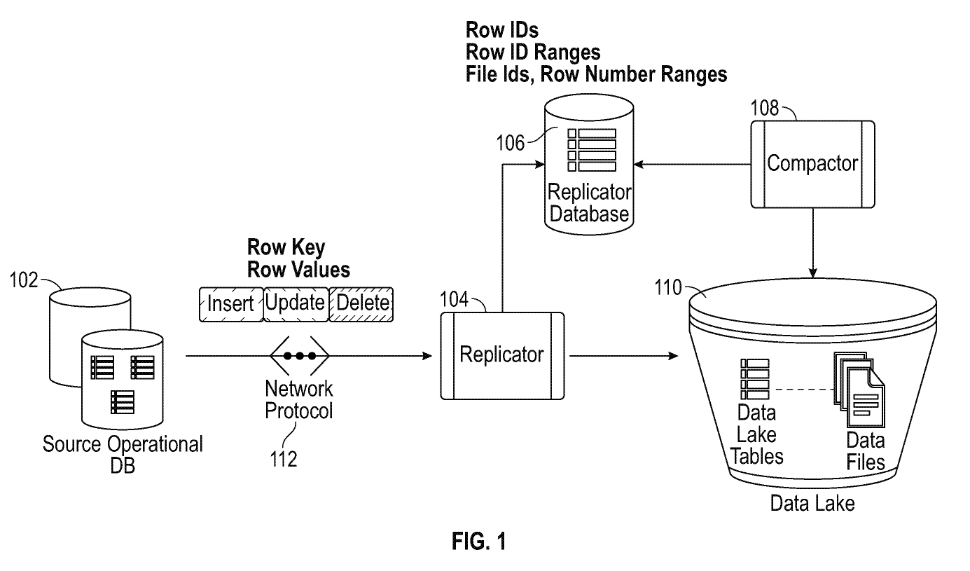

FIG. 1 illustrates a high-level system architecture for a streaming data replication system in accordance with one or more embodiments of the subject technology. The system enables efficient row-level replication from an operational database to a data lake table using logical row identifiers and specialized data structures.

FIG. 1 shows a system architecture that includes (1) a source operational database 102 (labeled “Source Operational DB”), that emits changes over a network protocol 112, (2) a replicator 104 (labeled “Replicator”) that translates the changes received over the network protocol 112 using an algorithm described in more detail below, (3) replicator database 106 (labeled ”Replicator Database”) that is created (defined) in a relational database management system to track the stream of row-level changes, (4) a compactor 108 (labeled ”Compactor”) that compacts multiple small data into a larger data file and merges the deletion files as described in more detail below, and (5) data lake 110 stored a set of data lake tables (labeled “Data lake tables”) to be updated with the changes emitted by the source operational database 102. More specifically, as shown in FIG. 1, a table can be created in a database management system including source operational database 102 (the ”Source Operational DB”), which supports emitting a stream of row-level changes via a network to be applied against a data lake table (with the “Data lake tables” of the data lake 110). The stream of changes is consumed by a second server (referred to as the replicator 104), which will apply them to a data lake table.

As shown in FIG. 1, the system includes source operational database 102 that generates change data capture events corresponding to data modifications occurring within the operational database. The source operational database 102 may comprise any relational database management system, such as PostgreSQL, MySQL, Oracle, SQL Server, or other database systems capable of generating change data capture events. The change data capture events indicate row-level operations including insert operations, update operations, and delete operations performed on database tables.

The system further includes replicator 104 that receives the change data capture events from the source operational database 102 via network protocol 112. The network protocol 112 may comprise any suitable communication protocol for transmitting database change events, including but not limited to logical replication protocols, transaction log streaming protocols, or custom change data capture protocols. The replicator 104 is configured to process three types of operations as indicated in the figure: INSERT operations, UPDATE operations, and DELETE operations. Each operation includes a row key that uniquely identifies the row being modified.

The replicator 104 interfaces with replicator database 106 that maintains several data structures for efficiently tracking and managing row-level changes. The replicator database 106 stores a key-to-identifier mapping that associates row keys with row values and logical row identifiers. Additionally, the replicator database 106 maintains row ID ranges and file ID mappings that associate ranges of logical row identifiers with specific file locations in the data lake. In some embodiments, the replicator database 106 comprises a relational database management system that provides transactional consistency and efficient lookup operations. The data structures within the replicator database 106 enable the replicator 104 to process individual change events with logarithmic time complexity.

The system also includes a compactor 108 that is operatively connected to the replicator database 106. The compactor 108 is configured to perform compaction operations on data files in the data lake 110 by consolidating files that contain invalidated rows or that have fallen below size thresholds. The compactor 108 accesses identifier-to-range mappings and deletion information stored in the replicator database 106 to identify files requiring compaction and to determine which rows remain valid during the compaction process.

The target of the replication system is a data lake 110 that stores data in one or more data files organized as tables. The data lake 110 may comprise cloud-based object storage systems such as Amazon S3, Azure Blob Storage, Google Cloud Storage, or other distributed file systems. Data files in the data lake 110 are immutable once written, meaning that updates and deletes are handled through deletion marking rather than in-place modification. The replicator 104 periodically flushes accumulated changes from the replicator database 106 to the data lake 110 by writing new data files and deletion files that reflect the tracked changes.

The architecture depicted in FIG. 1 provides several technical advantages over conventional merge-based replication approaches. By maintaining logical row identifiers separate from physical file locations and row numbers, the system enables efficient compaction operations that do not require updating the primary key-to-identifier mapping, thereby avoiding blocking the replication process during compaction. The two-phase processing architecture, wherein individual changes are tracked with logarithmic complexity and batched changes are flushed with linear complexity, provides superior performance for high-throughput replication scenarios. The separation of the replicator 104 and compactor 108 components allows these operations to proceed concurrently with minimal synchronization overhead, as discussed in greater detail with respect to subsequent figures.

By introducing logical row identifiers as an intermediate layer between primary keys and physical row locations, the system described herein separates the key-to-identifier mappings from the identifier-to-range mappings. The key-to-identifier mapping associates row keys with logical row identifiers that remain stable across the lifetime of a row, independent of physical file locations. The identifier-to-range mapping associates ranges of logical row identifiers with file locations in the data lake 110. When compaction changes the physical positions of rows, only the identifier-to-range mapping is updated to reflect the new file locations. The key-to-identifier mapping is not modified during compaction. As a result, the compactor 108 operates without blocking the replicator 104 from processing incoming change data capture events, and the update to the replicator database 106 during compaction is limited to the identifier-to-range mapping, which is smaller than the key-to-identifier mapping.

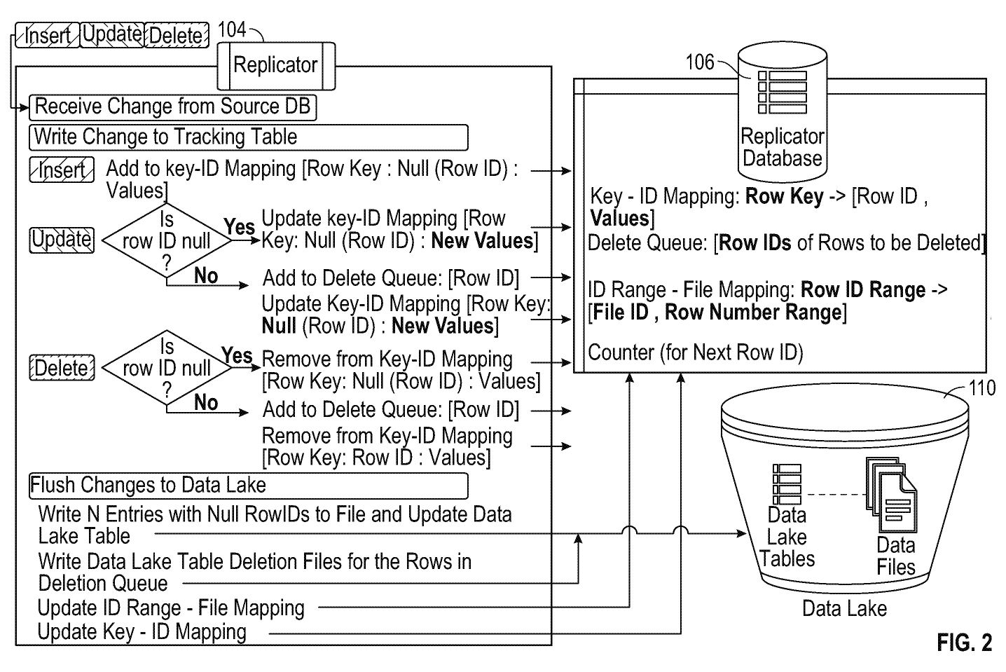

FIG. 2 illustrates a detailed operational flow diagram of the replicator 104 component and its interaction with the replicator database 106 in accordance with one or more embodiments of the subject technology. The figure depicts the processing logic for handling insert, update, and delete operations, as well as the periodic flush operation that writes accumulated changes to the data lake.

FIG. 2 shows an example of the replicator that translates the changes received over the network protocol using the algorithm described in more detail below including (1) receiving the changes over the network protocol 112, (2) translating and writing changes to the replicator database 106 having a data structure, and (3) flushing those changes to the data lake table in data lake 110. More specifically, as shown in FIG. 2, the replicator database 106 records several persistent data structures that are used to process individual change: (i) the ”Key-ID Mapping” (also referred to herein as an “key-to-identifier mapping”) data structure records a “row key mapping” of all “row keys” in the source table to a logical ”row ID” (or null) and the full value of the row (or null); (ii) the “Delete Queue” data structure records a “delete queue” containing to-be-deleted “row IDs”; (iii) the “ID Range-File Mapping” (also referred to herein as an “identifier-to-range mapping”) data structure records a ”row ID range mapping” that maps a ”row ID” range to a ”file ID” and row number range; and (iv) the “Counter” data structure records a counter R of the next new “row ID”. The replicator state can be kept in the replicator database 106 which can be either in the database management system server (e.g., the source operational database 102) that is generating the changes that are intended to be tracked, or in a separate database management system.

As shown in FIG. 2, the replicator 104 receives change events from the source database and processes each change based on the operation type. The replicator database 106 maintains several specialized data structures including: a Key-ID Mapping that associates row keys with logical row identifiers and row values; a Delete Queue that stores logical row identifiers for rows to be deleted; an ID Range-File Mapping that associates ranges of row identifiers with file locations and row number ranges in the data lake; and a Counter that tracks the next available row identifier for assignment during flush operations. The logical row identifiers of rows to be deleted stored by the Delete Queue correspond to rows that have been previously flushed to the data lake table and are pending deletion from the data lake table during the next flush operation.

For INSERT operations, the replicator 104 adds a new entry to the Key-ID Mapping with the format [Row Key: Null (Row ID): Values]. The row identifier is initially set to null, indicating that the row has been added to the tracking structure but has not yet been assigned a permanent logical row identifier or flushed to the data lake 110. This deferred identifier assignment enables efficient batching of changes during the subsequent flush operation.

For UPDATE operations, the replicator 104 follows a conditional processing path based on whether the existing row identifier in the Key-ID Mapping is null or non-null. If the row identifier is null, indicating the row has not yet been flushed to the data lake, the replicator 104 simply updates the Key-ID Mapping with the new values while maintaining the null row identifier, in the format [Row Key: Null (Row ID): New values]. No entry is added to the Delete Queue because the row does not yet exist in the data lake. Conversely, if the row identifier is non-null, indicating the row has been previously flushed to the data lake, the replicator 104 performs two operations: first, it adds the existing row identifier to the Delete Queue to mark the old version for deletion; and second, it updates the Key-ID Mapping with the new values and resets the row identifier to null, in the format [Row Key: Null (Row ID): New values]. This two-phase update approach ensures that the old version of the row in the data lake is marked for deletion while the new version is staged for the next flush operation.

For DELETE operations, the replicator 104 similarly follows a conditional processing path based on whether the row identifier is null or non-null. If the row identifier is null, the replicator 104 simply removes the entry from the Key-ID Mapping, as the row never existed in the data lake and therefore requires no deletion marking. If the row identifier is non-null, the replicator 104 performs two operations: first, it adds the row identifier to the Delete Queue; and second, it removes the entry from the Key-ID Mapping. This ensures that the row is marked for deletion in the data lake while the key mapping is cleaned up to reflect that the row no longer exists.

The bottom portion of FIG. 2 illustrates the flush operation that periodically transfers accumulated changes from the replicator database 106 to the data lake 110. During the flush operation, the replicator 104 identifies N entries in the Key-ID Mapping that have null row identifiers. For these entries, the replicator 104 assigns sequential row identifiers starting from the Counter, writes the corresponding row values to one or more new data files in the data lake 110, and updates the ID Range-File Mapping to associate the newly assigned row identifier ranges with the file locations. The Counter is incremented by N to reserve the next block of available row identifiers for subsequent flush operations.

Additionally, during the flush operation, the replicator 104 writes deletion files to the data lake 110 for all row identifiers contained in the Delete Queue.. These deletion files include records identifying the physical row numbers or offsets within previously written data files that correspond to the logical row identifiers in the Delete Queue. The deletion files thereby indicate which rows from previously written data files are no longer valid and should be excluded from query results. In this manner, the system translates update and delete operations, which are expressed in terms of primary keys in the source database, into deletion files that reference physical row numbers within data files in the data lake table. After successfully writing the deletion files and updating the metadata of the data lake table, the Delete Queue is cleared. The replicator 104 also updates the metadata of the data lake table to reference the newly written data files and deletion files in a single transaction on the underlying database system, ensuring that subsequent queries reflect the most recent changes. Through the combination of the Key-ID Mapping and the ID Range-File Mapping, the replicator 104 translates row keys from change data capture events into physical row numbers within data files in the data lake 110. When a change data capture event indicates an update or delete operation, the replicator 104 looks up the row key in the Key-ID Mapping to obtain the logical row identifier, which is added to the Delete Queue. During the flush operation, the replicator 104 uses the ID Range-File Mapping to resolve each logical row identifier in the Delete Queue to a file identifier and a physical row number within that file. The resulting deletion files reference these physical row numbers.

The processing logic depicted in FIG. 2 achieves several important performance characteristics. Individual change operations (insert, update, delete) are processed with O(log(N)), where N is the number of rows in the data lake table, time complexity through efficient lookups in the Key-ID Mapping, which may be implemented as a B-tree or similar indexed data structure. This per-event processing overhead is comparable to the work that an operational database performs to apply the same change to its own table.The flush operation processes C accumulated changes with O(C) time complexity, as it writes changes in batch without requiring reads from the existing data lake files. The deferred assignment of row identifiers enables efficient sequential writes to the data lake and maintains compact ID Range-File Mapping entries. The conditional processing of updates and deletes based on row identifier status ensures correctness while minimizing unnecessary operations on the Delete Queue.

FIG. 2 further illustrates the separation between the tracking phase (top portion) and the flush phase (bottom portion), which enables the two-phase processing architecture of the present invention. During the tracking phase, the replicator 104 processes individual changes as they arrive from the source database with minimal overhead. During the flush phase, executed periodically based on time intervals or accumulated change thresholds, the replicator 104 performs batch operations to write changes to the data lake 110. This separation enables the system to maintain low replication lag while efficiently handling high-throughput change streams, as the tracking phase can continue processing new changes even while a flush operation is in progress, subject to appropriate synchronization mechanisms.

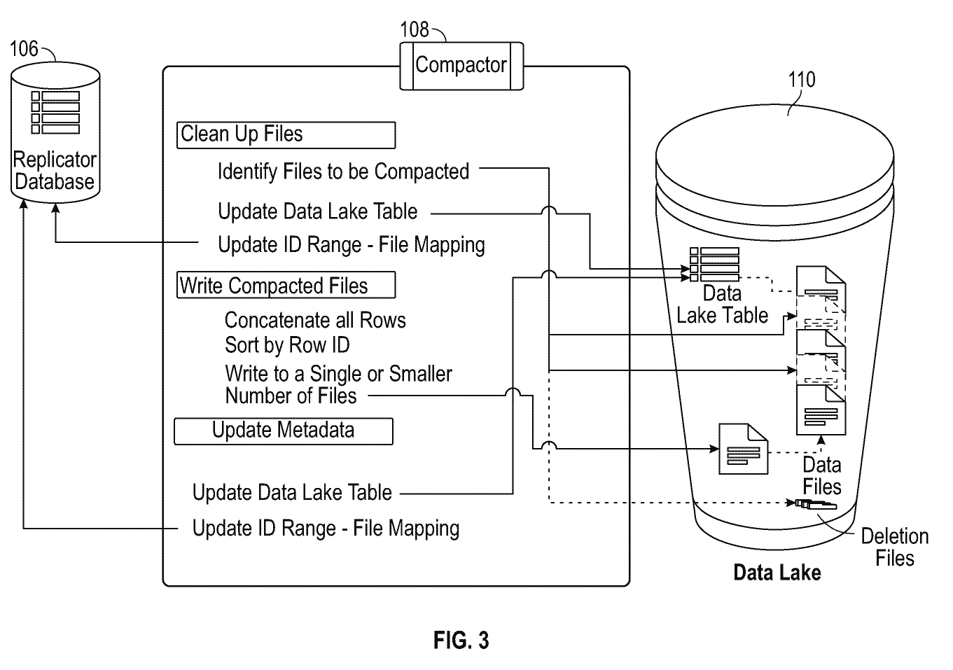

FIG. 3 illustrates a detailed operational flow diagram of the compaction process performed by the compactor 108 component in accordance with one or more embodiments of the subject technology. The compaction process consolidates multiple data files in the data lake that contain invalidated rows or have fallen below size thresholds, thereby improving query performance and reducing storage overhead.

As shown in FIG. 3, the compactor 108 initiates the compaction process by identifying files to be compacted. The identification process may be based on various criteria including file size falling below a predetermined size threshold or a percentage of invalidated rows exceeding a deletion percentage threshold. For example, the compactor 108 may identify files where the ratio of deleted rows to total rows exceeds a configurable threshold such as 20%, 30%, or 50%. Additionally, the compactor 108 may identify files whose size has fallen below a minimum threshold due to deletions, making them candidates for consolidation with other small files to achieve optimal file sizes for query performance.

Once the files to be compacted are identified, the compactor 108 accesses the replicator database 106 to update the ID Range-File Mapping. Specifically, the compactor 108 removes the mapping entries corresponding to the identified files from the ID Range-File Mapping. This removal operation disassociates the row identifier ranges from the old file locations that will be consolidated. Importantly, this operation does not modify the Key-ID Mapping, which continues to associate row keys with logical row identifiers and values. The independence of the compaction process from the Key-ID Mapping is an advantage of the logical row identifier architecture, as it enables compaction to proceed without expensive updates to the primary key mapping structure and without blocking replication. The ID Range-File mapping is smaller than the Key-ID mapping because the ID Range-File mapping stores one entry per contiguous range of logical row identifiers within a file, whereas the Key-ID mapping stores one entry per row in the data lake table. For a data lake table containing N rows distributed across F files, the ID Range-File mapping may contain as few as F entries, while the Key-ID mapping contains N entries. Because the compactor 108 modifies only the ID Range-File mapping and not the Key-ID mapping, the change made to the replicator database 106 during each compaction operation is proportional to the number of files being compacted rather than to the number of rows in the table.

The compactor 108 then retrieves the rows from the identified files in the data lake 110 and concatenates all rows from the multiple files being consolidated. During this concatenation process, the compactor 108 uses an antijoin construction with the deletion files that have been previously written to the data lake table to determine which rows have been marked for deletion. Rows whose physical row numbers appear in the deletion files are excluded from the concatenated result, filtering out invalidated rows during the compaction operation. This ensures that the compacted file contains only valid, current rows.

After concatenating and filtering the rows, the compactor 108 sorts the rows by row identifier. This sorting operation ensures that rows in the compacted file are stored in sequential order according to their logical row identifiers. The sorted arrangement provides several advantages including improved query performance through better data locality, more compact representation in the ID Range-File Mapping, and efficient range-based filtering during query execution. In embodiments where the rows already have sequential or mostly sequential row identifiers, the sorting operation may be performed efficiently with minimal overhead.

The compactor 108 then writes the sorted, filtered rows to a single file or a smaller number of files in the data lake 110. The consolidated file or files are written as new immutable data files using the object storage interface of the data lake 110. The number of output files may be determined based on target file size parameters to achieve optimal query performance. For example, the compactor 108 may target a file size in the range of 100 MB to 1 GB per file, splitting the consolidated data across multiple files if necessary to maintain files within the target size range.

Following the successful writing of the compacted file or files, the compactor 108 updates the metadata of the data lake table. This metadata update includes two distinct operations: first, removing references to the identified files that were consolidated, effectively marking them as no longer part of the active table; and second, adding references to the newly written compacted file or files. In embodiments where the replicator database 106 and the data lake catalog database are the same database system, these metadata updates can be performed atomically within a single transaction to ensure consistency. In embodiments where these databases are separate systems, a distributed transaction protocol such as two-phase commit may be employed to ensure atomic updates across both systems.

file_id + row_number_offset]. This compact representation maintains the efficiency of the ID Range-File Mapping even as the data lake table grows in size. The compactor 108 sorts the rows within each compacted file by logical row identifier to maintain continuous ranges in the ID Range-File Mapping. In some embodiments, the compactor 108 may use additional data structures such as bitmaps to compactly represent gaps in ranges of logical row identifiers within a file.

Finally, as indicated in FIG. 3, the compactor 108 performs a clean up files operation. In accordance with one or more embodiments, rather than immediately deleting the consolidated files from the data lake 110 storage system, the identifiers of these files are added to a file deletion queue for deferred removal. A separate cleanup process subsequently removes the files from physical storage after an expiration period has elapsed. This deferred deletion approach provides important safety benefits including the ability to roll back compaction operations in case of errors, support for time-travel queries that reference historical file versions, and protection against premature deletion of files that may still be referenced by in-progress queries or transactions.

The compaction process depicted in FIG. 3 operates independently of and concurrently with the replication process shown in FIG. 2, with synchronization required only when both processes need to modify the ID Range-File Mapping. Because the compaction process does not access or modify the Key-ID Mapping or the delete queue, and because individual change operations processed by the replicator 104 do not access the ID Range-File Mapping except during flush operations, the two processes can largely operate in parallel with minimal locking overhead. This concurrent operation enables the system to maintain both low replication lag and high query performance through continuous background compaction, without one process blocking or significantly slowing the other.

The compaction process further provides important performance benefits for query execution. By consolidating small files and removing rows referenced by deletion files, compaction reduces the number of files that must be scanned during query execution and eliminates the overhead of filtering deleted rows at query time. As described with respect to FIG. 3, the compactor 108 sorts rows by logical row identifier within compacted files. This sorting enables range-based pruning during queries that include filters on the primary key, as entire files can be skipped if their row identifier ranges do not overlap with the query predicate.

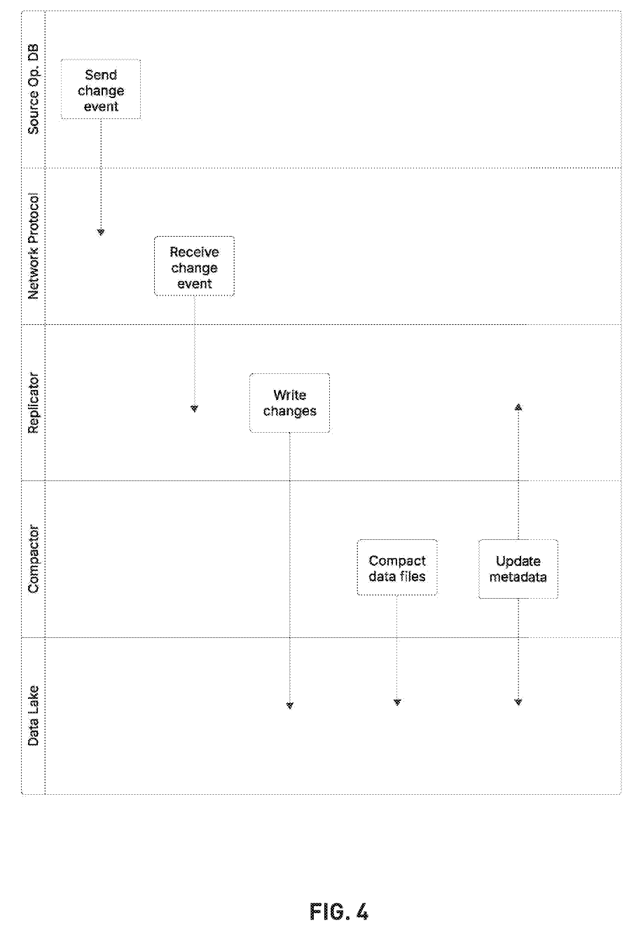

FIG. 4 illustrates a high-level process flow diagram showing the end-to-end operation of the streaming data replication system in accordance with one or more embodiments of the subject technology. The figure depicts the sequential processing stages from change event generation in the source operational database through final compaction and metadata updates in the data lake.

As shown in FIG. 4, the process begins at the source operational database 102, which sends change events via a network protocol 112. The change events correspond to row-level modifications occurring within the operational database, including insert operations, update operations, and delete operations. The network protocol 112 may comprise a logical replication protocol, transaction log streaming protocol, or other change data capture mechanism that transmits change events in near real-time from the source database to the replication system.

The replicator 104 receives the change events from the network protocol 112 and writes the changes to the replicator database 106. As described in detail with respect to FIG. 2, the replicator 104 processes each change event by performing lookups and updates to the specialized data structures maintained in the replicator database 106, including the Key-ID Mapping, Delete Queue, and counter. The write changes operation depicted in FIG. 4 encompasses the tracking phase processing described in FIG. 2, wherein individual change operations are processed with O(log(N)) time complexity through efficient data structure operations.

Following the tracking of changes in the replicator database 106, the replicator 104 periodically flushes accumulated changes to the data lake 110. This flush operation, indicated by the arrow from the replicator database 106 to the data lake 110, corresponds to the flush phase processing described in detail with respect to FIG. 2. During the flush operation, the replicator 104 assigns logical row identifiers to newly inserted or updated rows, writes data files and deletion files to the data lake 110, and updates the ID Range-File Mapping and metadata of the data lake table to reflect the new files.

In parallel with or subsequent to the replication process, the compactor 108 operates on the data lake 110 to compact data files. As indicated in FIG. 4, the compactor 108 reads from the data lake 110, performs compaction operations on files containing invalidated rows or files that have fallen below size thresholds, and writes compacted files back to the data lake 110. The compaction process consolidates multiple small or sparse files into larger, more efficiently organized files, as described in detail with respect to FIG. 3.

After writing the compacted files to the data lake 110, the compactor 108 updates the metadata of the data lake table. This metadata update operation includes removing references to the original files that were compacted and adding references to the newly created compacted files.This metadata update operation includes removing references to the original files that were compacted and adding references to the newly created compacted files. The compactor 108 also updates the ID Range-File Mapping in the replicator database 106 to associate the row identifier ranges contained in the compacted files with the new file locations, as described with respect to FIG. 3. In one or more embodiments, the metadata updates are performed atomically to maintain consistency of the data lake table during concurrent query operations.

The process flow depicted in FIG. 4 illustrates the continuous, cyclical nature of the streaming replication system. As the source operational database 102 continues to generate change events, the replicator 104 continuously receives and processes these changes, periodically flushing accumulated changes to the data lake 110. Simultaneously, the compactor 108 continuously monitors the data lake files and performs compaction operations on files that meet the compaction criteria. This continuous operation enables the system to maintain both low replication lag and high query performance, as new changes are rapidly propagated to the data lake while compaction ensures that the file structure remains optimized for query execution.

FIG. 4 further illustrates the separation of concerns within the system architecture. The replicator 104 is responsible for capturing and applying changes from the source database with minimal latency, while the compactor 108 is responsible for optimizing the physical file layout in the data lake. These two processes operate largely independently, with synchronization required only when both need to modify shared data structures such as the ID Range-File Mapping. This architectural separation enables the system to scale effectively, as the replication and compaction workloads can be distributed across different compute resources and can proceed at different rates based on system load and performance requirements.

The overall process flow provides important advantages over conventional data lake replication approaches. By separating the tracking phase (write changes to Replicator Database) from the flush phase (write to Data Lake), the system achieves low latency for individual change operations while maintaining efficient batch writes to the data lake. By separating the replication process from the compaction process, the system ensures that ongoing replication is not blocked by resource-intensive compaction operations. By maintaining specialized data structures in the replicator database 106 that are much smaller than the data lake table itself, the system enables efficient change processing that scales independently of the total data lake size. By generating deletion files that contain physical row numbers rather than primary keys, the deleted rows can be filtered out by a query engine accessing the data lake table without performing a join on primary keys at query time, which would otherwise be computationally expensive. These architectural characteristics enable the system to maintain consistent performance even as the data lake grows to very large sizes and as the rate of incoming changes increases.

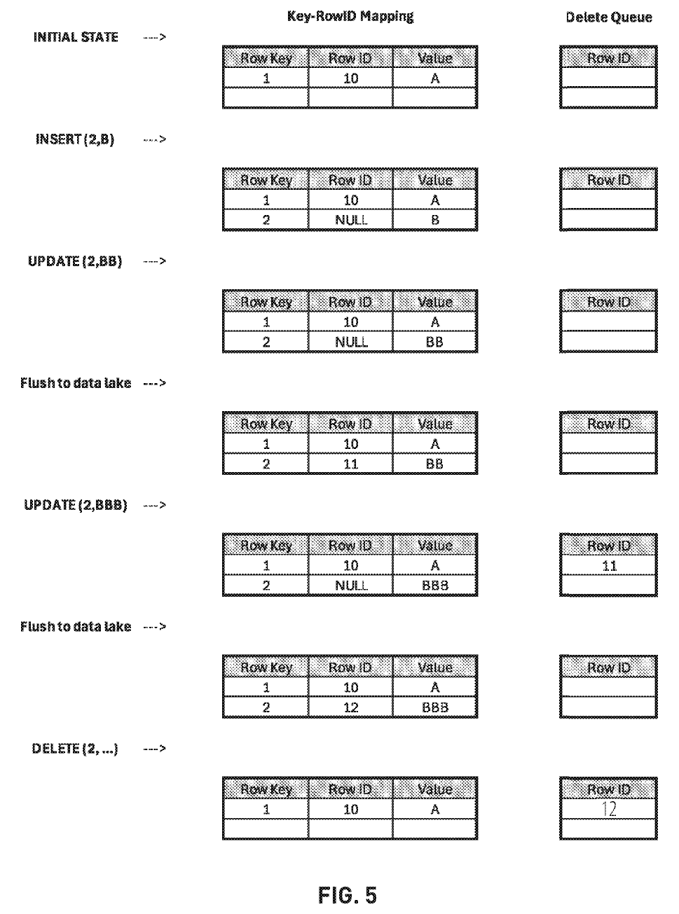

FIG. 5 illustrates an example state progression of Key-ID Mapping and Delete Queue data structures as they process a sequence of change operations in accordance with one or more embodiments of the subject technology. FIG. 5 illustrates how the system handles insert operations, update operations on both unflushed and flushed rows, flush operations, and delete operations through a concrete example involving two row keys.

In this example, FIG. 5 depicts seven sequential states starting from an initial state and progressing through various operations. The Key-ID Mapping table shows three columns: Row Key, Row ID, and Value. The Delete Queue is shown as a separate structure containing Row IDs that have been marked for deletion from the data lake.

In the initial state, the Key-ID Mapping contains a single entry with Row Key “1”, Row ID “10”, and Value “A”. This represents a row that has been previously flushed to the data lake and assigned the logical row identifier 10. The Delete Queue is empty, indicating no rows are currently marked for deletion.

Upon receiving an INSERT operation for row key “2” with value “B”, the system adds a new entry to the Key-ID Mapping with Row Key “2”, Row ID “NULL”, and Value “B”. The NULL row ID indicates that this row has been added to the tracking structure but has not yet been assigned a permanent logical row identifier or flushed to the data lake. The Delete Queue remains empty.

When an UPDATE operation is received for row key “2” with new value “BB”, the system examines the existing entry in the Key-ID Mapping and determines that the Row ID is NULL. Because the row has not yet been flushed to the data lake, the system simply updates the Value field to “BB” while maintaining the NULL row ID. Importantly, no entry is added to the Delete Queue in this scenario, as the row does not yet exist in the data lake and therefore requires no deletion marking. This demonstrates the first type of update scenario where updates to unflushed rows are handled efficiently without generating deletion records.

The next operation shown is a flush to data lake operation. During this flush, the system identifies the entry with Row Key “2” that has a NULL row ID. The system assigns the next available logical row identifier, which is 11 in this example, to this row. The Key-ID Mapping is updated to show Row Key “2”, Row ID “11”, and Value “BB”. The corresponding row value is written to a data file in the data lake, and the ID Range-File Mapping (not shown in this figure) is updated to associate row ID 11 with the file location. After the flush operation completes successfully, the Delete Queue is cleared and remains empty, as all pending deletions have been written to deletion files in the data lake.

Following the first flush, an UPDATE operation is received for row key “2” with new value “BBB”. In this case, the system examines the Key-ID Mapping and finds that Row Key “2” has a non-NULL row ID of 11, indicating that this row has been previously flushed to the data lake. The system therefore performs two operations: first, it adds the existing row ID “11” to the Delete Queue to mark the old version of the row for deletion; and second, it updates the Key-ID Mapping to show Row Key “2”, Row ID “NULL”, and Value “BBB”, resetting the row ID to NULL to indicate that the new value has not yet been flushed. This demonstrates the second type of update scenario where updates to previously flushed rows generate deletion records for the old versions.

A second flush to data lake operation then occurs. During this flush, the system identifies the entry with Row Key “2” that has a NULL row ID and assigns the next available logical row identifier, which is 12. The Key-ID Mapping is updated to show Row Key “2”, Row ID “12”, and Value “BBB”. The corresponding row value is written to a new data file in the data lake. Simultaneously, the system writes a deletion file indicating that row ID 11 is no longer valid. After this flush operation completes successfully, the Delete Queue is cleared and becomes empty, as the pending deletion of row ID 11 has been written to the deletion files.

Finally, a DELETE operation is received for row key “2”. The system examines the Key-ID Mapping and finds that Row Key “2” has a non-NULL row ID of 12. The system performs two operations: first, it adds row ID “12” to the Delete Queue; and second, it removes the entry for Row Key “2” from the Key-ID Mapping. The final state shows the Key-ID Mapping containing only Row Key “1” with Row ID “10” and Value “A”, while the Delete Queue contains row ID “12” pending deletion. In this example, the Delete Queue only includes row ID “12” in the final state because row ID “11” was properly cleared after the second flush operation.

FIG. 5 illustrates several important aspects of the system’s operation. First, it demonstrates the use of NULL row IDs to track rows that have been added or updated but not yet flushed to the data lake. Second, it shows the distinction between updates to unflushed rows (which do not add entries to the Delete Queue) and updates to flushed rows (which do add entries to the Delete Queue). Third, it demonstrates how the Delete Queue is populated during update and delete operations and is cleared after each flush operation when the deletion records are successfully written to the data lake. Fourth, it shows how logical row IDs are assigned sequentially during flush operations, with row ID 11 assigned during the first flush and row ID 12 assigned during the second flush. These mechanisms enable the system to efficiently track and apply a stream of changes while maintaining correctness and consistency between the replicator database 106 and the data lake 110.

The state progression shown in FIG. 5 also illustrates the memory efficiency of the tracking structures. At no point does the Key-ID Mapping contain more than two entries, even though multiple operations have been processed. The Delete Queue remains small, containing at most one or two row IDs pending deletion before each flush clears the queue. This compact representation enables the system to efficiently track changes for very large tables, as the size of the tracking structures is proportional to the number of unique keys that have been recently modified, not to the total size of the data lake table.

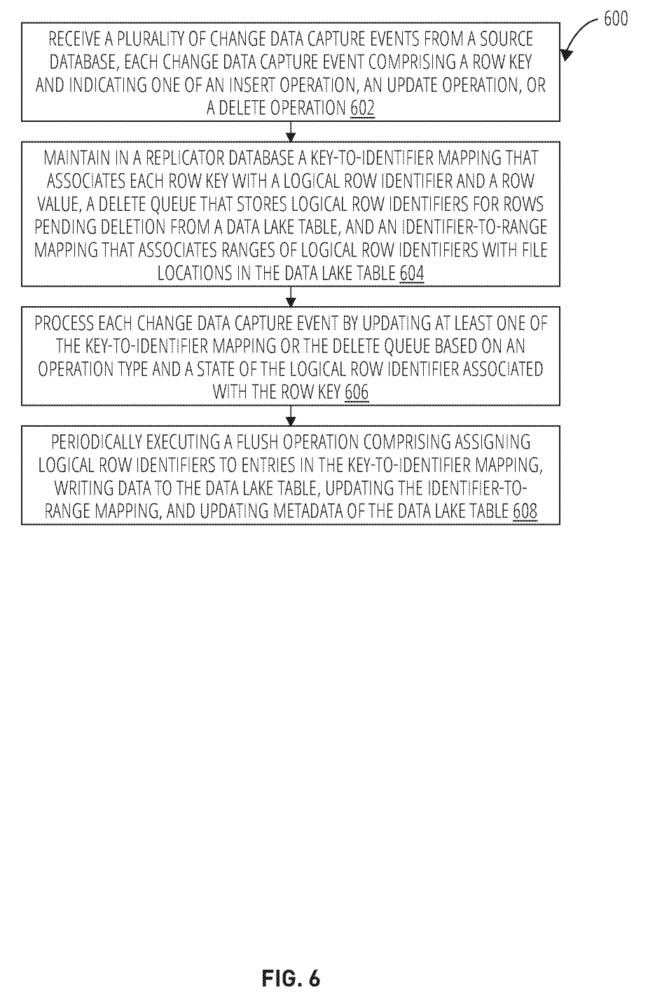

FIG. 6 is a flow diagram illustrating operations of a system in performing a method 600, in accordance with some embodiments of the present disclosure. The method 600 may be embodied in computer-readable instructions for execution by one or more hardware components (e.g., one or more processors) such that the operations of the method 600 may be performed by components including source operational database 102, replicator 104, or replicator database 106. Accordingly, the method 600 is described below, by way of example with reference thereto. However, it shall be appreciated that method 600 may be deployed on various other hardware configurations and is not intended to be limited to source operational database 102, replicator 104, or replicator database 106.

In operation 602, replicator 104 receives a plurality of change data capture events from a source database (e.g., source operational database 102), each change data capture event comprising a row key and indicating one of an insert operation, an update operation, or a delete operation. In operation 604, replicator 104 maintains in a replicator database (e.g., replicator database 106) a key-to-identifier mapping that associates each row key with a logical row identifier and a row value, a delete queue that stores logical row identifiers for rows pending deletion from a data lake table (e.g., stored in data lake 110), and an identifier-to-range mapping that associates ranges of logical row identifiers with file locations in the data lake table. In operation 606, replicator 104 processes each change data capture event by updating at least one of the key-to-identifier mapping or the delete queue based on an operation type and a state of the logical row identifier associated with the row key. In operation 608, replicator 104 periodically executing a flush operation comprising assigning logical row identifiers to entries in the key-to-identifier mapping, writing data to the data lake table (e.g., provided by data lake 110), updating the identifier-to-range mapping, and updating metadata of the data lake table.

As mentioned herein, the following terms or phrases may refer to the following:

Change Data Capture Event: A record or message indicating a row-level modification that has occurred in a source database, including insert operations, update operations, or delete operations, along with associated data such as row keys and row values.

Catalog Database: A database system that stores metadata about data lake tables, including information about file locations, schema definitions, table statistics, and references to active data files and deletion files.

Compaction: A process of consolidating multiple data files in a data lake table into a smaller number of larger data files, typically by removing invalidated rows and combining small or sparse files to improve query performance and reduce storage overhead.

Compactor: A component or process that performs compaction operations on data files in a data lake table by identifying files meeting compaction criteria, retrieving valid rows, writing consolidated files, and updating associated mappings and metadata.

Consolidated Data File: A data file created during a compaction operation that contains valid rows from multiple source data files, typically sorted by logical row identifier and with invalidated rows excluded.

Counter: A numeric value maintained in a replicator database that tracks the next available logical row identifier to be assigned during flush operations, incremented after each flush by the number of identifiers assigned.

Data Lake: A storage system, typically comprising cloud-based object storage or distributed file systems, that stores large volumes of data in files organized as tables, where files are generally immutable once written.

Data Lake Table: A logical table structure within a data lake comprising multiple immutable data files and associated metadata, where the table can be queried using database query languages and engines.

Delete Queue: A data structure maintained in a replicator database that stores logical row identifiers for rows that have been deleted or updated and are pending deletion from the data lake table during the next flush operation.

Deletion File: A file written to a data lake table that contains records indicating the physical row numbers or offsets within previously written data files that are no longer valid and should be excluded from query results.

Deletion Percentage Threshold: A configurable threshold value representing a percentage of invalidated rows in a data file, used as a criterion for identifying files for compaction, typically ranging from 10% to 50%.

Deletion Record: An entry in a deletion file that indicates a specific physical row number or offset within a data file is no longer valid and should be treated as deleted when processing queries against the data lake table. When a row is updated, a deletion record is created for the previous version of the row stored at its prior physical row location, while the new version of the row is written to a new data file during the next flush operation. When a row is deleted, a deletion record is created for the current version of the row, and no new version is written.

Expiration Period: A time duration after which files that have been consolidated during compaction operations may be safely removed from physical storage, providing a safety window for rollback operations and error recovery.

File Deletion Queue: A data structure that stores identifiers of data files that have been consolidated or removed from a data lake table but have not yet been physically deleted from storage, enabling deferred deletion after an expiration period.

Flush Operation: A periodic operation in which accumulated changes tracked in the replicator database are written to the data lake table by assigning logical row identifiers, writing data files and deletion files, and updating mappings and metadata.

Identifier-to-Range Mapping: A data structure maintained in a replicator database that associates ranges of logical row identifiers with file locations in the data lake table, enabling efficient lookup of which file contains a given row identifier. Also referred to as “ID Range-File Mapping” or “row ID range mapping.”

Insert Operation: A change data capture event indicating that a new row with a specified row key and row value has been added to a source database table.

Key-to-Identifier Mapping: A data structure maintained in a replicator database that associates each row key with a logical row identifier (which may be null) and a row value, enabling efficient tracking and lookup of current row states. Also referred to as “Key-ID Mapping” or “row key mapping.”

Logical Row Identifier: A numeric identifier assigned to a row during a flush operation that uniquely identifies the row within the data lake table and remains stable across the row’s lifetime, independent of the physical file location or row number within a file. Also referred to as “row ID.”

Metadata: Information about the structure and contents of a data lake table, including references to active data files, deletion files, schema definitions, file locations, and statistics, typically stored in a catalog database.

Network Protocol: A communication protocol or mechanism used to transmit change data capture events from a source operational database to a replicator component, including logical replication protocols, transaction log streaming protocols, or custom change data capture protocols.

Non-Null Logical Row Identifier: A logical row identifier that has been assigned a numeric value, indicating that the associated row has been flushed to the data lake table and exists in one or more data files.

Null Logical Row Identifier: A logical row identifier with a null or empty value, indicating that the associated row has been added to the key-to-identifier mapping but has not yet been assigned a permanent identifier or flushed to the data lake table.

Object Storage: A cloud-based storage system such as Amazon S3, Azure Blob Storage, or Google Cloud Storage that stores data as objects or blobs, typically accessed via HTTP-based APIs and providing scalable, durable storage for data lake files.

Operational Database: A source database system that handles transactional workloads and generates change data capture events corresponding to insert, update, and delete operations performed on database tables.

Replicator: A component or process that receives change data capture events from a source database, maintains tracking data structures in a replicator database, and periodically flushes accumulated changes to a data lake table.

Replicator Database: A database system that stores specialized data structures for tracking row-level changes, including the key-to-identifier mapping, delete queue, identifier-to-range mapping, and counter, enabling efficient processing of change data capture events.

Row Key: A value or set of values that uniquely identifies a row within a table, typically corresponding to the primary key of the row in the source operational database.

Row Number: A sequential position of a row within a specific data file, starting from 0 or 1 for the first row in the file, distinct from the logical row identifier which is unique across all files in the table.

Row Value: The data content of a row, including all column values other than the primary key, represented in the key-to-identifier mapping and written to data files during flush operations.

Sequential Logical Row Identifiers: A continuous range of logical row identifiers assigned during a single flush operation, typically stored compactly in the identifier-to-range mapping as a single entry with a starting identifier and ending identifier.

Size Threshold: A configurable file size value used as a criterion for identifying data files for compaction, where files whose size falls below the threshold are candidates for consolidation with other files.

Source Database: See “Operational Database.”

Synchronization Mechanism: A locking, coordination, or concurrency control mechanism used to prevent conflicts when multiple processes such as the replicator flush operation and compactor process need to access or modify shared data structures such as the identifier-to-range mapping.

Tracking Phase: The phase of replication processing in which individual change data capture events are received and processed by updating the key-to-identifier mapping and delete queue, performed with O(log(N)) time complexity for each event.

Two-Phase Processing Architecture: An architectural approach in which replication is separated into a tracking phase that processes individual changes with logarithmic complexity and a flush phase that writes accumulated changes with linear complexity, enabling efficient high-throughput replication.

Update Operation: A change data capture event indicating that an existing row with a specified row key has been modified to have a new row value in the source database table.

Delete Operation: A change data capture event indicating that a row with a specified row key has been removed from the source database table.

Valid Row: A row in a data file whose logical row identifier does not appear in the delete queue or deletion files, indicating the row represents current data and should be included in query results and compaction operations.

Invalidated Row: A row in a data file whose logical row identifier appears in the delete queue or deletion files, indicating the row has been deleted or updated and should be excluded from query results and removed during compaction operations.

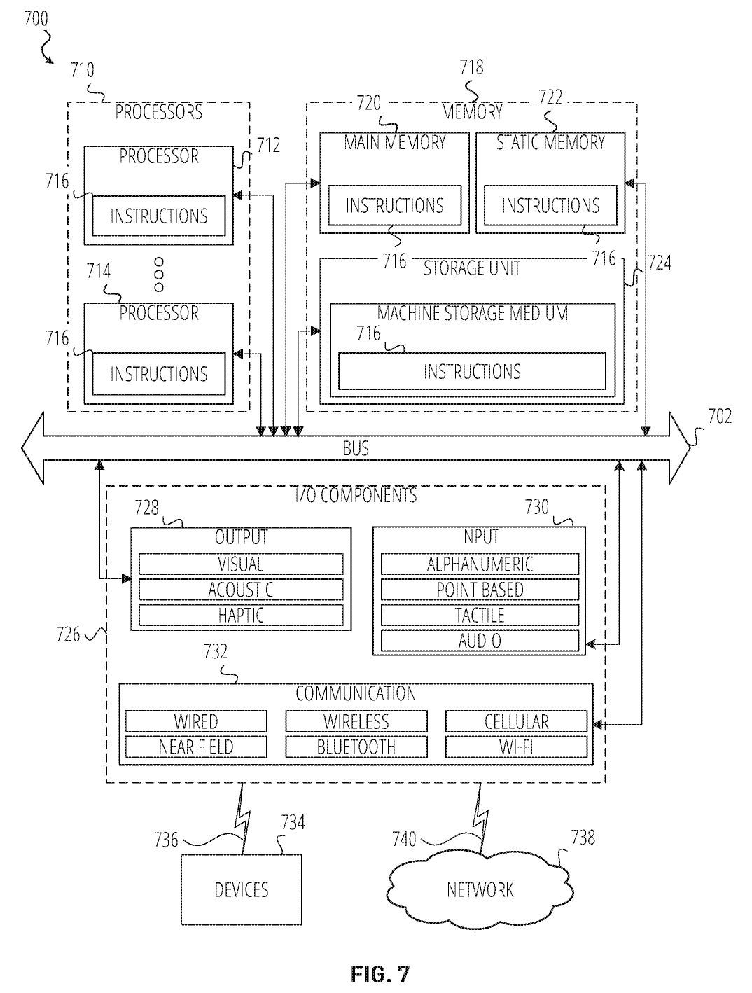

FIG. 7 illustrates a diagrammatic representation of a machine 700 in the form of a computer system within which a set of instructions may be executed for causing the machine 700 to perform any one or more of the methodologies discussed herein, according to an example embodiment. Specifically, FIG. 7 shows a diagrammatic representation of the machine 700 in the example form of a computer system, within which instructions 716 (e.g., a software, a program, an application, an applet, an app, or other executable code) for causing the machine 700 to perform any one or more of the methodologies discussed herein may be executed. For example, the instructions 716 may cause the machine 700 to execute any one or more operations of the method(s) described herein. As another example, the instructions 716 may cause the machine 700 to implement any one or more portions of the functionality illustrated in any one of the disclosed figures. In this way, the instructions 716 transform a general, non-programmed machine into a particular machine that is specially configured to carry out any one of the described and illustrated functions of the aforementioned figures.

In some embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 includes processors 710, memory 718, and i/o components 726 configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 714 and a processor 712 that may execute the instructions 716. The term “processor” is intended to include multi-core processors 710that may comprise two or more independent processors (sometimes referred to as “cores”) that may execute instructions 716 contemporaneously. Although FIG. 7 shows multiple processors 710, the machine 700 may include a single processor with a single core, a single processor with multiple cores (e.g., a multi-core processor), multiple processors with a single core, multiple processors with multiple cores, or any combination thereof.

The memory 718 may include a main memory 720, a static memory 722, and a storage unit 724, all accessible to the processors 710 such as via the bus 702. The main memory 720, the static memory 722, and the storage unit 724 store the instructions 716 embodying any one or more of the methodologies or functions described herein. The instructions 716 may also reside, completely or partially, within the main memory 720, within the static memory 722, within the storage unit 724, within at least one of the processors 710 (e.g., within the processor’s cache memory), or any suitable combination thereof, during execution thereof by the machine 700.

The i/o components 726 include components to receive input, provide output, produce output, transmit information, exchange information, capture measurements, and so on. The specific i/o components 726 that are included in a particular machine 700 will depend on the type of machine. For example, portable machines such as mobile phones will likely include a touch input device or other such input mechanisms, while a headless server machine will likely not include such a touch input device. It will be appreciated that the i/o components 726 may include many other components that are not shown in FIG. 7. The i/o components 726 are grouped according to functionality merely for simplifying the following discussion and the grouping is in no way limiting. In various example embodiments, the i/o components 726 may include output components 728 and input components 730. The output components 728 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 730 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The i/o components 726 may include communication components 732 operable to couple the machine 700 to a network 738 or devices 734 via a coupling 740 and a coupling 736, respectively. For example, the communication components 732 may include a network interface component or another suitable device to interface with the network 738. In further examples, the communication components 732 may include wired communication components, wireless communication components, cellular communication components, and other communication components to provide communication via other modalities. The devices 734 may be another machine or any of a wide variety of peripheral devices (e.g., a peripheral device coupled via a universal serial bus (USB)).

The various memories (e.g., memory 718, main memory 720, static memory 722, and/or memory of the processor(s) 710 and/or the storage unit 724) may store one or more sets of instructions 716 and data structures (e.g., software) embodying or utilized by any one or more of the methodologies or functions described herein. These instructions 716, when executed by the processor(s) 710, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In various example embodiments, one or more portions of the network 738 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 738 or a portion of the network 738 may include a wireless or cellular network, and the coupling 740 may be a Code Division Multiple Access (CDMA) connection, a Global System for Mobile communications (GSM) connection, or another type of cellular or wireless coupling. In this example, the coupling 740 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 716 may be transmitted or received over the network 738 using a transmission medium via a network interface device (e.g., a network interface component included in the communication components 732) and utilizing any one of a number of well-known transfer protocols (e.g., hypertext transfer protocol (HTTP)). Similarly, the instructions 716 may be transmitted or received using a transmission medium via the coupling 736 (e.g., a peer-to-peer coupling) to the devices 734. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of a method may be performed by one or more processors. The performance of certain of the operations may be distributed among the one or more processors, not only residing within a single machine, but also deployed across a number of machines. In some example embodiments, the processor or processors may be in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
receiving a plurality of change data capture events from a source database, each change data capture event comprising a row key and indicating one of an insert operation, an update operation, or a delete operation;
maintaining in a replicator database a key-to-identifier mapping that associates each row key with a logical row identifier and a row value, a delete queue that stores logical row identifiers for rows pending deletion from a data lake table, and an identifier-to-range mapping that associates ranges of logical row identifiers with file locations in the data lake table;
processing each change data capture event by updating at least one of the key-to-identifier mapping or the delete queue based on an operation type and a state of the logical row identifier associated with the row key;
periodically executing a flush operation comprising assigning logical row identifiers to entries in the key-to-identifier mapping, writing data to the data lake table, updating the identifier-to-range mapping, and updating metadata of the data lake table.

2. The system of claim 1, wherein processing each change data capture event indicating an insert operation comprises adding an entry to the key-to-identifier mapping with the row key, a null logical row identifier, and the row value.

3. The system of claim 1, wherein processing each change data capture event indicating an update operation comprises:
if the row key exists in the key-to-identifier mapping with a null logical row identifier, updating the row value without adding an entry to the delete queue; and
if the row key exists in the key-to-identifier mapping with a non-null logical row identifier, adding the non-null logical row identifier to the delete queue, updating the row value, and resetting the logical row identifier to null.

4. The system of claim 1, wherein processing each change data capture event indicating a delete operation comprises:
if the row key exists in the key-to-identifier mapping with a null logical row identifier, removing the entry from the key-to-identifier mapping without adding an entry to the delete queue; and
if the row key exists in the key-to-identifier mapping with a non-null logical row identifier, adding the non-null logical row identifier to the delete queue and removing the entry from the key-to-identifier mapping.

5. The system of claim 1, wherein the flush operation comprises identifying entries in the key-to-identifier mapping having null logical row identifiers, assigning sequential logical row identifiers from a counter to the identified entries, writing corresponding row values to one or more new data files in the data lake table, writing deletion records for logical row identifiers in the delete queue to one or more deletion files in the data lake table, updating the identifier-to-range mapping to associate the assigned sequential logical row identifiers with locations of the one or more new data files, and updating metadata of the data lake table to reference the one or more new data files and the one or more deletion files.

6. The system of claim 5, wherein the operations further comprise:
clearing the delete queue after successfully writing the deletion records to the one or more deletion files.

7. The system of claim 1, wherein the replicator database and a catalog database for the data lake table comprise a same database system, and wherein updating metadata of the data lake table comprises updating catalog records within a single atomic database transaction that also commits updates to the key-to-identifier mapping, the delete queue, and the identifier-to-range mapping.

8. The system of claim 1, wherein the operations further comprise:
identifying one or more data files in the data lake table for compaction based on at least one of file size falling below a size threshold or a percentage of invalidated rows exceeding a deletion percentage threshold, retrieving valid rows from the identified one or more data files by excluding rows identified in deletion files previously written to the data lake table , writing the valid rows to a consolidated data file, updating the identifier-to-range mapping to associate a consolidated logical row identifier range with a location of the consolidated data file, and updating metadata of the data lake table to remove references to the identified one or more data files and to add a reference to the consolidated data file.

9. The system of claim 8, wherein updating metadata of the data lake table to remove references to the identified one or more data files comprises adding identifiers of the identified one or more data files to a file deletion queue for deferred removal from storage after an expiration period.

10. The system of claim 1, wherein the operations further comprise:
processing individual change data capture events concurrently with compaction operations without requiring locks between the processing and the compaction operations, and coordinating the flush operation with compaction operations using synchronization mechanisms when both operations access the identifier-to-range mapping.

11. A method comprising:
receiving a plurality of change data capture events from a source database, each change data capture event comprising a row key and indicating one of an insert operation, an update operation, or a delete operation;
maintaining in a replicator database a key-to-identifier mapping that associates each row key with a logical row identifier and a row value, a delete queue that stores logical row identifiers for rows pending deletion from a data lake table, and an identifier-to-range mapping that associates ranges of logical row identifiers with file locations in the data lake table;
processing each change data capture event by updating at least one of the key-to-identifier mapping or the delete queue based on an operation type and a state of the logical row identifier associated with the row key;
periodically executing a flush operation comprising assigning logical row identifiers to entries in the key-to-identifier mapping, writing data to the data lake table, updating the identifier-to-range mapping, and updating metadata of the data lake table.

12. The method of claim 11, wherein processing each change data capture event indicating an insert operation comprises adding an entry to the key-to-identifier mapping with the row key, a null logical row identifier, and the row value.

13. The method of claim 11, wherein processing each change data capture event indicating an update operation comprises:
if the row key exists in the key-to-identifier mapping with a null logical row identifier, updating the row value without adding an entry to the delete queue; and
if the row key exists in the key-to-identifier mapping with a non-null logical row identifier, adding the non-null logical row identifier to the delete queue, updating the row value, and resetting the logical row identifier to null.

14. The method of claim 11, wherein processing each change data capture event indicating a delete operation comprises:
if the row key exists in the key-to-identifier mapping with a null logical row identifier, removing the entry from the key-to-identifier mapping without adding an entry to the delete queue; and
if the row key exists in the key-to-identifier mapping with a non-null logical row identifier, adding the non-null logical row identifier to the delete queue and removing the entry from the key-to-identifier mapping.

15. The method of claim 11, wherein the flush operation comprises identifying entries in the key-to-identifier mapping having null logical row identifiers, assigning sequential logical row identifiers from a counter to the identified entries, writing corresponding row values to one or more new data files in the data lake table, writing deletion records for logical row identifiers in the delete queue to one or more deletion files in the data lake table, updating the identifier-to-range mapping to associate the assigned sequential logical row identifiers with locations of the one or more new data files, and updating metadata of the data lake table to reference the one or more new data files and the one or more deletion files.

16. The method of claim 15, further comprising:
clearing the delete queue after successfully writing the deletion records to the one or more deletion files.

17. The method of claim 11, wherein the replicator database and a catalog database for the data lake table comprise a same database system, and wherein updating metadata of the data lake table comprises updating catalog records within a single atomic database transaction that also commits updates to the key-to-identifier mapping, the delete queue, and the identifier-to-range mapping.

18. The method of claim 11, further comprising:
identifying one or more data files in the data lake table for compaction based on at least one of file size falling below a size threshold or a percentage of invalidated rows exceeding a deletion percentage threshold, retrieving valid rows from the identified one or more data files by excluding rows identified in deletion files previously written to the data lake table, writing the valid rows to a consolidated data file, updating the identifier-to-range mapping to associate a consolidated logical row identifier range with a location of the consolidated data file, and updating metadata of the data lake table to remove references to the identified one or more data files and to add a reference to the consolidated data file.

19. The method of claim 18, wherein updating metadata of the data lake table to remove references to the identified one or more data files comprises adding identifiers of the identified one or more data files to a file deletion queue for deferred removal from storage after an expiration period.

20. A non-transitory computer-storage medium comprising instructions that, when executed by one or more processors of a machine, configure the machine to perform operations comprising:
receiving a plurality of change data capture events from a source database, each change data capture event comprising a row key and indicating one of an insert operation, an update operation, or a delete operation;
maintaining in a replicator database a key-to-identifier mapping that associates each row key with a logical row identifier and a row value, a delete queue that stores logical row identifiers for rows pending deletion from a data lake table, and an identifier-to-range mapping that associates ranges of logical row identifiers with file locations in the data lake table;
processing each change data capture event by updating at least one of the key-to-identifier mapping or the delete queue based on an operation type and a state of the logical row identifier associated with the row key;
periodically executing a flush operation comprising assigning logical row identifiers to entries in the key-to-identifier mapping, writing data to the data lake table, updating the identifier-to-range mapping, and updating metadata of the data lake table.
